(19) United States
(12) Patent Application Publication
(10) Pub. No.: US 2018/0030375 A1
(43) Pub. Date: Feb. 1, 2018

(54) FRAGRANCE COMPOSITION REPRODUCING THE AROMA OF CITRUS FLOWERS

(71) Applicant: AMOREPACIFIC CORPORATION, Seoul (KR)

(72) Inventors: Dae Young HAM, Yongin-si, Gyeonggi-do (KR); Seung-Ho KO, Yongin-si, Gyeonggi-do (KR)

(73) Assignee: AMOREPACIFIC CORPORATION, Seoul (KR)

(21) Appl. No.: 15/548,867

(22) PCT Filed: Jan. 8, 2016
(86) PCT No.: PCT/KR2016/000192

§ 371 Date: Aug. 4, 2017

(30) Foreign Application Priority Data
Feb. 6, 2015 (KR) 10-2015-0018549

(51) Int. Cl. C11B 9/00; A61Q 13/00

(52) U.S. Cl. CPC C11B 9/0061; C11B 9/003; C11B 9/0049; C11B 9/0015; A61Q 13/00; C11B 9/02

(57) ABSTRACT

The fragrance composition of Citrus flowers according to the present invention is produced by respectively adding jasmone and β-caryophyllene to linalool, myrcene, nerolidol, methyl anthranilate or the like which have been analyzed to be aromatic components of the flowers of Citrus unshin and the flowers of Citrus natsudaidai by means of the SPME method, and by adding γ-terpinene to linalool, myrcene, geraniol, β-ocimene or the like which have been analyzed to be aromatic components of the flowers of Citrus sudachi, and also adding α-farnesene to β-ocimene, 6-methyl-5-hepten-2-one, anthranilaldehyde, limonene, methyl anthranilate or the like which have been analyzed to be aromatic components of the flowers of Citrus japonica. The present invention makes it possible to provide a fragrance composition which is outstandingly palatable while reproducing the inherent aromas of Citrus unshin, Citrus natsudaidai, Citrus sudachi and Citrus japonica.

### TECHNICAL FIELD

The present invention relates to a fragrance composition for reproducing the aroma of Citrus flowers, and more particularly, to a fragrance composition for reproducing the aroma of Citrus unshiu, Citrus natsudaidai, Citrus sudachi, and Fortunella japonica.

This application claims priority to and the benefit of Korean Patent Application No. 10-2015-0018549 filed in the Korean Intellectual Property Office on Feb. 6, 2015, the entire disclosure of which are incorporated herein by reference in its entirety.

### BACKGROUND ART

Citrus unshiu is an evergreen fruit tree that belongs to the genus Citrus of the family Rutaceae, stands 3 to 5 m in height, and has branches spreading out and no thorns. Leaves are alternating and in an oval shape with plain edges and unclear wings of leafstalks. Also, Citrus unshiu has white flowers and five pairs of sepals and petals with one pistil and many stamens. Citrus unshiu grows in Korea, Japan, Latin America, the Black Sea, etc.

Also, Citrus natsudaidai is an evergreen fruit tree that belongs to the genus Citrus of the family Rutaceae, stands 3 to 5 m in height, and has branches spreading out. Leaves are alternating, thick, and in an oval shape with unclear wings of leafstalks. Also, the edges of the leaves are saw-toothed and pellucid dots are present throughout the leaves. Citrus natsudaidai come into flowers one by one and has white flowers, five petals, one pistil and approximately 30 stamens. Fruits are in an oblate shape, have a diameter of 10 to 15 cm and a thick and rough peel, and ripen to brass yellow. The fruits mature in the fall, but remain on the tree for a long period and are harvested in the summer. For this reason, Citrus natsudaidai is also referred to as a summer orange. Citrus natsudaidai tastes sour, is rich in vitamin C and native to Japan.

Citrus sudachi is an evergreen shrub that belongs to the genus Citrus of the family Rutaceae. Fruits taste sour like lemon or lime, and are harvested while they are green because the fruits of Citrus sudachi do not mature unlike Citrus unshiu. Citrus sudachi has white flowers blooming in May and July, and is native to Japan.

Fortunella japonica is an evergreen shrub that belongs to the genus Fortunella of the family Rutaceae, and also is a general term for fruits thereof. In general, Fortunella japonica stands approximately 2.5 to 4.5 m in height, sprouts deep green leaves, and has dense branches with thorns. Fortunella japonica produces small oval fruits having a length of 3 to 5 cm and a width of 2 to 4 cm, is native to China and grown in the East Asia.

Citrus unshiu is well known as a specialty of Jeju-do to Korean people, and is a fruit that is popular in winter season. Tangerines familiar in Jeju-do include Citrus natsudaidai, Citrus sudachi, and Fortunella japonica as well as Citrus unshiu. However, although many people like the aroma of Citrus flowers, there is no research conducted on a fragrance composition for reproducing the aroma of Citrus flowers. Therefore, the present invention has been designed based on the research on the aroma of flowers of Citrus unshiu, Citrus natsudaidai, Citrus sudachi, and Fortunella japonica.

There may be a variety of methods of reproducing the aroma of Citrus flowers. For example, conventional methods includes a solvent extraction method of preparing aromatic components of Citrus flowers in the form of absolute flavor oil and a steam distillation method of preparing aromatic components of Citrus flowers in the form of essential oil. However, the methods have a limitation in that the resulting oil has an aroma highly different from the inherent aroma because high heat has to be applied to the Citrus flowers during an extraction process and much time is required due to a complicated treatment process.

In recent years, a solid-phase micro-extraction method (hereinafter referred to as a SPME method; SUPELCO international, Vol. 13, No. 4, p. 9-10) and a headspace method have been developed to make up for these drawbacks. Among these, the SPME method is disclosed in the article (SUPELCO International, Vol. 13, No. 4, p. 9-10), the entire contents of which are incorporated herein by reference in its entirety. Unlike conventional extraction methods, the SPME method may be used to quickly and easily analyze the aromatic components because it neither uses a solvent nor requires a pretreatment process as well. However, when a fragrance is prepared using only main components of the analyzed aroma in this way, the fragrance has poor similarity and insufficient palatability. Therefore, the SPME method has limits in reproducing the aroma of a target substance.

Unlike the conventional extraction methods, the headspace method also has an advantage in that it may be used to quickly and easily analyze the aromatic components because it neither uses a solvent nor requires a pretreatment process as well. On the other hand, the headspace method has drawbacks in that it is possible to easily analyze highly volatile aromatic components, but it is impossible to easily analyze aromatic components that is poorly volatile or has a high molecular weight.

Meanwhile, gas chromatography (GC) is an instrumental analysis method that is very useful in qualitatively and quantitatively analyzing volatile compounds, and thus has been widely used to analyze all types of aromatic components. However, among the aromatic components, there are aromatic components that emit strong smells due to a very low threshold value even when present at a low concentration, whereas there are aromatic components that do not emit smells due to a very high threshold value even when present at a high concentration. Therefore, it cannot merely exclude the possibility that the volatile components quantitatively mainly found through GC are main aromatic components of a certain substance. To solve these problems, an analysis method using gas chromatography-olfactometry (GC-O; Guth H, Grosch W (1993) Lebensm Wiss U Technol, 196, 22-28) has been developed to be used. The CG-O is not a method of analyzing aromatic components through the chromatogram's peaks which are not observed at the same time but a method of identifying the components that actually emit smells while directly smelling a scent.

### DISCLOSURE

### Technical Problem

Although many people like the aroma of Citrus unshiu, Citrus natsudaidai, Citrus sudachi, and Fortunella japonica, a fragrance composition for reproducing the aroma of these Citrus flowers is not still provided to the public. Therefore, the present invention is provided to solve the above problems.

Accordingly, it is an aspect of the present invention to provide a fragrance composition having excellent palatability by reproducing the inherent aromas of each of Citrus unshiu, Citrus natsudaidai, Citrus sudachi, and Fortunella japonica.

The present inventors have tried to reproduce the aroma of Citrus unshiu, Citrus natsudaidai, Citrus sudachi, and Fortunella japonica using an SPME method which is effective in analyzing aromatic components of a natural substance. As a result, the present inventors have found that linalool, myrcene, and the like are common main components of the flowery aroma from Citrus unshiu, Citrus natsudaidai, and Citrus sudachi, all of which belong to the same genus, and confirmed that the two components determine the main aroma of Citrus unshiu, Citrus natsudaidai, and Citrus sudachi, and there are main components that determine their aromas. It can be seen that the main components of Citrus unshiu and Citrus natsudaidai are nerolidol, and methyl anthranilate, and the main components of Citrus sudachi are geraniol, and β-ocimene. Also, it can be seen that the main components of Fortunella japonica are β-ocimene, 6-methyl-5-hepten-2-one, anthranilaldehyde, limonene, and methyl anthranilate. Based on these facts, the present inventors have prepared a combined fragrance to reproduce the aroma of Citrus unshiu, Citrus natsudaidai, Citrus sudachi, and Fortunella japonica, but found that, when these aromatic components are subjected to a sensory test, it is impossible to reproduce the aroma of the Citrus flowers using only these aromatic components.

Therefore, it is a specific aspect of the present invention to provide a fragrance composition capable of distinguishing a difference in inherent aromas between Citrus unshiu, Citrus natsudaidai, Citrus sudachi, and Fortunella japonica and reproducing the inherent aromas of the Citrus flowers and having excellent palatability.

It is another aspect of the present invention to provide a skin preparation for external use including the fragrance composition.

### Technical Solution

To solve the above problems, according to an aspect of the present invention, there is provided a fragrance composition for reproducing the aroma of Citrus unshiu, Citrus natsudaidai, Citrus sudachi, and Fortunella japonica. Here, the fragrance composition according to the present invention includes one selected from the group consisting of jasmone, β-caryophyllene, γ-terpinene, α-farnesene and a combination thereof in addition to the main aromatic components of the flowers of Citrus unshiu extracted and analyzed through a SPME method.

For this purpose, the present inventors have conducted research to reproduce the aroma of Citrus unshiu, Citrus natsudaidai, Citrus sudachi, and Fortunella japonica, and found that the flowers of Citrus unshiu include linalool, myrcene, nerolidol, and methyl anthranilate as the main components, and a fragrance composition including jasmone as an active ingredient may reproduce the inherent aroma of Citrus unshiu.

Also, the present inventors have found that the flowers of Citrus natsudaidai include linalool, myrcene, nerolidol, and methyl anthranilate as the main components, and a fragrance composition including β-caryophyllene as the active ingredient may reproduce the inherent aroma of Citrus natsudaidai.

In addition, the present inventors have found that the flowers of Citrus sudachi include linalool, myrcene, geraniol, and β-ocimene as the main components, and a fragrance composition including γ-terpinene as the active ingredient may reproduce the inherent aroma of Citrus sudachi.

Additionally, the present inventors have found that the flowers of Fortunella japonica include β-ocimene, 6-methyl-5-hepten-2-one, anthranilaldehyde, limonene, and methyl anthranilate as the main components, and a fragrance composition including α-farnesene as the active ingredient may reproduce the inherent aroma of Fortunella japonica include.

Further, the present inventors have found that all the fragrance compositions have excellent palatability. Therefore, the present invention has been completed based on these facts.

The technical solution of the present invention will be described in detail, as follows. First, to reproduce the aroma of Citrus unshiu, there is provided a fragrance composition which includes aromatic components including 60 to 69% by weight of linalool, 4.5 to 6.5% by weight of myrcene, 4.2 to 5.6% by weight of nerolidol, and 3.8 to 5.3% by weight of methyl anthranilate and further includes 0.9 to 5% by weight of jasmone.

Second, to reproduce the aroma of Citrus natsudaidai, there is provided a fragrance composition which includes aromatic components including 50 to 60% by weight of linalool, 18 to 23% by weight of methyl anthranilate, 8 to 12% by weight of nerolidol, and 3.8 to 6% by weight of myrcene and further includes 0.9 to 5% by weight of 3-caryophyllene.

Third, to reproduce the aroma of Citrus sudachi, there is provided a fragrance composition which includes aromatic components including 53 to 62% by weight of linalool, 10 to 15% by weight of myrcene, 3 to 7% by weight of geraniol, and 3 to 5% by weight of β-ocimene and further includes 0.9 to 5% by weight of γ-terpinene.

Fourth, to reproduce the aroma of Fortunella japonica, there is provided a fragrance composition which includes aromatic components including 17 to 25% by weight of β-ocimene, 10 to 16% by weight of 6-methyl-5-hepten-2-one, 9 to 14% by weight of anthranilaldehyde, 9 to 14% by weight of limonene, and 9 to 14% by weight of methyl anthranilate and further includes 0.9 to 5% by weight of α-farnesene.

### Advantageous Effects

According to the present invention, the fragrance composition which includes main components of the Citrus flowers extracted and analyzed through an SPME method and further includes each of jasmone, β-caryophyllene, γ-terpinene, and α-farnesene can be provided. Therefore, the fragrance composition according to the present invention can be useful in reproducing the aroma of Citrus unshiu, Citrus natsudaidai, Citrus sudachi, and Fortunella japonica and improving palatability to the aroma as well.

### BEST MODE

The present invention relates to a fragrance composition for reproducing the aroma of Citrus flowers. The fragrance composition of the present invention includes aromatic components of flowers of Citrus unshiu, Citrus natsudaidai, Citrus sudachi, and Fortunella japonica, and further includes one or more selected from jasmone, β-caryophyllene, γ-terpinene, and α-farnesene as active ingredients. Therefore, a fragrance composition for reproducing the aroma of the Citrus flowers through comparison the aromatic components of the Citrus flowers is provided. Unless particularly defined otherwise this specification, the term “active ingredient” refers to a component that is used alone or mixed with another component so that the fragrance composition has an effect in reproducing the aroma of the Citrus flowers.

In the present invention, the Citrus flowers are intended to include flowers of Citrus unshiu, Citrus natsudaidai, Citrus sudachi, and Fortunella japonica, based on the contents of examples. However, it will be apparent to persons having ordinary skill in the art to which the present invention belongs that the examples disclosed herein are not intended to limit the present invention without departing from the scope of the present invention. Hereinafter, the present invention will be described in further detail.

The composition according to one exemplary embodiment of the present invention includes the aromatic components of flowers of Citrus unshiu and further includes jasmone as an active ingredient; includes the aromatic components of flowers of Citrus natsudaidai and further includes β-caryophyllene as the active ingredient; includes the aromatic components of flowers of Citrus sudachi and further includes γ-terpinene as the active ingredient; or includes the aromatic components of flowers of Fortunella japonica and further includes α-farnesene as the active ingredient, and thus may be useful in reproducing the inherent aromas of the Citrus flowers and exhibiting excellent palatability.

The fragrance composition of Citrus unshiu according to one exemplary embodiment of the present invention includes 60 to 69% by weight of linalool, 4.5 to 6.5% by weight of myrcene, 4.2 to 5.6% by weight of nerolidol, 3.8 to 5.3% by weight of methyl anthranilate, 3 to 5.1% by weight of anthranilaldehyde, 3 to 5% by weight of 3,7-dimethyl-1,5-octadiene-3,7-diol, 2.8 to 4% by weight of phenylacetonitrile, 1.8 to 2.9% by weight of 6-methyl-5-hepten-2-one, 1.3 to 2.6% by weight of phenylethyl alcohol, 1 to 2% by weight of limonene, 0.1 to 1% by weight of indole, and 0.9 to 5% by weight of jasmone, based on the total weight of the composition.

The fragrance composition of Citrus natsudaidai according to one exemplary embodiment of the present invention includes 50 to 60% by weight of linalool, 18 to 23% by weight of methyl anthranilate, 8 to 12% by weight of nerolidol, 3.8 to 6% by weight of myrcene, 1.2 to 3% by weight of phenylethyl alcohol, 1 to 2.2% by weight of phenylacetonitrile, 0.7 to 1.8% by weight of 6-methyl-5-hepten-2-one, 0.6 to 1.2% by weight of 3,7-dimethyl-1,5-octadiene-3,7-diol, 0.5 to 1% by weight of limonene, 0.4 to 0.9% by weight of anthranilaldehyde, 0.3 to 0.8% by weight of indole, and 0.9 to 5% by weight of β-caryophyllene, based on the total weight of the composition.

The fragrance composition of Citrus sudachi according to one exemplary embodiment of the present invention includes 53 to 62% by weight of linalool, 10 to 15% by weight of myrcene, 3 to 7% by weight of geraniol, 3 to 5% by weight of β-ocimene, 3 to 5% by weight of 3,7-dimethyl-1,5-octadiene-3,7-diol, 2 to 4% by weight of phenylethyl alcohol, 1.9 to 3.7% by weight of phenylacetonitrile, 1.7 to 3.3% by weight of β-caryophyllene, 1.4 to 3% by weight of limonene, 1 to 2% by weight of 6-methyl-5-hepten-2-one, 0.7 to 1.5% by weight of nonanal, 0.1 to 1% by weight of indole, and 0.9 to 5% by weight of γ-terpinene, based on the total weight of the composition.

The fragrance composition of Fortunella japonica according to one exemplary embodiment of the present invention includes 17 to 25% by weight of β-ocimene, 10 to 16% by weight of 6-methyl-5-hepten-2-one, 9 to 14% by weight of anthranilaldehyde, 9 to 14% by weight of limonene, 9 to 14% by weight of methyl anthranilate, 5 to 8% by weight of ethyl acetate, 4 to 6% by weight of linalool, 4 to 6% by weight of nonanal, 4 to 6% by weight of decanal, 3 to 5% by weight of α-pinene, 0.6 to 1.7% by weight of acetophenone, 0.1 to 1% by weight of indole, and 0.9 to 5% by weight α-farnesene, based on the total weight of the composition.

As the main components used to reproduce the aroma of these Citrus flowers, linalool, myrcene, nerolidol, and methyl anthranilate should be used within these content ranges in the case of the flowers of Citrus unshiu and Citrus natsudaidai. Also, linalool, myrcene, geraniol, and β-ocimene should be used within the aforementioned content ranges in the case of the flowers of Citrus sudachi, and β-ocimene, 6-methyl-5-hepten-2-one, anthranilaldehyde, limonene, and methyl anthranilate should be used within the aforementioned content ranges in the case of the flowers of Fortunella japonica. When the contents of the components used fall out of these content ranges, similarity with the aroma may be lowered, and aroma palatability may also be reduced, both of which are undesirable. Also, only when jasmone of Citrus unshiu, β-caryophyllene of Citrus natsudaidai, γ-terpinene of Citrus sudachi, and α-farnesene of Fortunella japonica do not fall out of the aforementioned content ranges as the active ingredients, the similarity with the aroma and aroma palatability may be improved.

Beside the main components, the additional components are preferably used within content ranges provided herein, but do not have a great effect on the aroma of the Citrus flowers. Therefore, the additional components may be included at amounts falling out of the aforementioned content ranges as long as the additional components do not have an influence on reproducing the aroma of the Citrus flowers.

The composition according to the present invention may be blended with a skin base for external use such as perfumes, cosmetics, etc. In this case, the composition may be blended with the skin base for external use so that an amount of the blended skin base for external use may be properly chosen to achieve a desirable effect, depending on the technology generally known in the related art. For example, such a skin base for external use includes an ointment, a lotion, a solubilizing formulation, a suspension, an emulsion, a cream, a gel, a spray, cataplasma, a plaster, a patch, a pain reliever, etc., but the present invention is not limited thereto. For example, the skin base for external use may be prepared through blending with compositions of any skin base for external use known in the related art.

Meanwhile, in the present invention, a method of analyzing the aromatic components of the Citrus flowers is used as a solid-phase microextraction method (SPME). The SPME method is advantageous in analyzing highly volatile aromatic components of the Citrus flowers because the aromatic components adsorbed onto fibers may be desorbed and rapidly injected into a GS-MS column without any particular pretreatment, resulting in a highly shortened time of analysis. In the present invention, a combined fragrance is composed based on the aromatic components of the Citrus flowers analyzed by the SPME method, and an olfactory sensory test is performed on the combined fragrance to determine the similarity with the aroma of each of the Citrus flowers and aroma palatability. The sensory tests are performed by expert perfumers and general persons, and the similarity with the aroma of Citrus unshiu, Citrus natsudaidai, Citrus sudachi, and Fortunella japonica and the aroma palatability are evaluated using a survey.

### MODE FOR INVENTION

Hereinafter, the present invention will be described in further detail with reference to Examples thereof. However, it should be understood that the embodiments of the present invention can be implemented in various forms, but are not intended to limit the scope of the present invention, as apparent to persons having ordinary skill in the art.

### [Reference Example 1] Analysis of Aroma Citrus Unshiu, Citrus Natsudaidai, Citrus Sudachi, and Fortunella japonica Using SPME Method

A tree of each of Citrus unshiu, Citrus natsudaidai, Citrus sudachi, and Fortunella japonica, all of which had a strong scent, was selected to adsorb aromatic components onto an 85-μm-thick polyacrylate-coated fiber for 2 hours and collect the aromatic components. The collection was carried out for 3 hours in neighboring farms in Seogwipo-si, Jeju-do, and a container including the aromatic components were sealed with a fiber after the aromatic components were collected. Thereafter, the aromatic components were inserted into an inlet of a gas chromatograph-mass spectrometer (GC-MS), desorbed for 2 minutes, and then subjected to GC-MS analysis. The GC-MS analysis conditions are as follows.

Analytical Conditions
Analytical instrument: HP 5890 II GC
Detector: HP 5972 MSD
Column: DB-1 (60 m×0.25 mm×0.25 um)
Carrier gas: He
Injection temperature: 250° C.
Detector temperature: 280° C.
Oven temperature: 70° C. to 220° C. (3° C./min)
Ionization voltage: 70 eV
Desorption time: 2 minutes

As a result, the aromatic components of the Citrus flowers analyzed by the SPME method are listed in the following Tables 1 to 4.

TABLE 1

| Aromatic component of flowers of Citrus unshiu | Content (%) |
|---|---|
| Linalool | 67.25 |
| Myrcene | 5.63 |
| Nerolidol | 5.17 |
| Methyl anthranilate | 4.72 |
| Anthranilaldehyde | 1.57 |
| 3,7-Dimethyl-1,5-octadiene-3,7-diol | 1.42 |
| Phenylacetonitrile | 1.11 |
| 6-Methyl-5-hepten-2-one | 0.74 |
| Phenylethyl alcohol | 0.57 |
| Limonene | 0.52 |
| Indole | 0.47 |
| Others | 10.83 |
| Total content | 100 |

TABLE 2

| Aromatic component of flowers of Citrus natsudaidai | Content (%) |
|---|---|
| Linalool | 48.92 |
| Methyl anthranilate | 18.21 |
| Nerolidol | 9.17 |
| Myrcene | 4.42 |
| Phenylethyl alcohol | 2.15 |
| Phenylacetonitrile | 1.69 |
| 6-Methyl-5-hepten-2-one | 1.09 |
| 3,7-Dimethyl-1,5-octadiene-3,7-diol | 0.91 |
| Limonene | 0.80 |
| Anthranilaldehyde | 0.71 |
| Indole | 0.64 |
| Others | 11.29 |
| Total content | 100 |

TABLE 3

| Aromatic component of flowers of Citrus sudachi | Content (%) |
|---|---|
| Linalool | 57.90 |
| Myrcene | 12.23 |
| Geraniol | 5.12 |
| β-Ocimene | 4.31 |
| 3,7-Dimethyl-1,5-octadiene-3,7-diol | 1.69 |
| Phenylethyl alcohol | 1.34 |
| Phenylacetonitrile | 1.25 |
| β-Caryophyllene | 1.18 |
| limonene | 0.82 |
| 6-Methyl-5-hepten-2-one | 0.51 |
| Nonanal | 0.45 |
| Indole | 0.42 |
| Others | 12.78 |
| Total content | 100 |

TABLE 4

| Aromatic component of flowers of Fortunella japonica | Content (%) |
|---|---|
| β-Ocimene | 20.11 |
| 6-Methyl-5-hepten-2-one | 12.07 |
| Anthranilaldehyde | 10.73 |
| Limonene | 10.73 |
| Methyl anthranilate | 10.73 |
| Ethyl acetate | 5.31 |
| Linalool | 4.1 |
| Nonanal | 4.1 |
| Decanal | 4.1 |
| α-Pinene | 2.98 |
| Acetophenone | 1.2 |
| Indole | 0.73 |
| Others | 13.11 |
| Total content | 100 |

As listed in Tables 1 and 2, it was revealed that Citrus unshiu and Citrus natsudaidai included linalool, myrcene, nerolidol, and methyl anthranilate as the main aromatic components, and such main components accounted for 82.77% and 80.72% of the entire components of Citrus unshiu and Citrus natsudaidai, respectively. As listed in Table 3, it was also revealed that Citrus sudachi included linalool, myrcene, geraniol, and β-ocimene as the main aromatic components, and such main components accounted for 79.66% of the entire components of Citrus sudachi. Finally, as listed in Table 4, it was revealed that Fortunella japonica included β-ocimene, 6-methyl-5-hepten-2-one, anthranilaldehyde, limonene, and methyl anthranilate as the main aromatic components, and such main components accounted for 64.37% of the entire components of Fortunella japonica.

### [Reference Example 2] Comparative Sensory Evaluation Between Fragrances Composed from Analysis Results and Aroma of Natural Citrus Flowers

Combined fragrances (Samples E, F, G, and H) having compositions as listed in the following Tables 5 to 8 were prepared based on the analysis results, and the similarity between the combined fragrances and the aroma of natural Citrus flowers was verified through the sensory evaluation.

TABLE 5

| Fragrance names of Citrus unshiu | Content (%) |
|---|---|
| Linalool | 67.25 |
| Myrcene | 5.63 |
| Nerolidol | 5.17 |
| Methyl anthranilate | 4.72 |
| Anthranilaldehyde | 1.57 |
| 3,7-Dimethyl-1,5-octadiene-3,7-diol | 1.42 |
| Phenylacetonitrile | 1.11 |
| 6-Methyl-5-hepten-2-one | 0.74 |
| Phenylethyl alcohol | 0.57 |
| Limonene | 0.52 |
| Indole | 0.47 |
| DPG (solvent) | 10.83 |
| Total content | 100 |

TABLE 6

| Fragrance names of Citrus natsudaidai | Content (%) |
|---|---|
| Linalool | 48.92 |
| Methyl anthranilate | 18.21 |
| Nerolidol | 9.17 |
| Myrcene | 4.42 |
| Phenylethyl alcohol | 2.15 |
| Phenylacetonitrile | 1.69 |
| 6-Methyl-5-hepten-2-one | 1.09 |
| 3,7-Dimethyl-1,5-octadiene-3,7-diol | 0.91 |
| Limonene | 0.80 |
| Anthranilaldehyde | 0.71 |
| Indole | 0.64 |
| DPG (solvent) | 11.29 |
| Total content | 100 |

TABLE 7

| Fragrance names of Citrus sudachi | Content (%) |
|---|---|
| Linalool | 57.90 |
| Myrcene | 12.23 |
| Geraniol | 5.12 |
| β-Ocimene | 4.31 |
| 3,7-Dimethyl-1,5-octadiene-3,7-diol | 1.69 |
| Phenylethyl alcohol | 1.34 |
| Phenylacetonitrile | 1.25 |
| β-Caryophyllene | 1.18 |
| Limonene | 0.82 |
| 6-Methyl-5-hepten-2-one | 0.51 |
| Nonanal | 0.45 |
| Indole | 0.42 |
| DPG (solvent) | 12.78 |
| Total content | 100 |

TABLE 8

| Fragrance names of Fortunella japonica | Content (%) |
|---|---|
| β-Ocimene | 20.11 |
| 6-Methyl-5-hepten-2-one | 12.07 |
| Anthranilaldehyde | 10.73 |
| Limonene | 10.73 |
| Methyl anthranilate | 10.73 |
| Ethyl acetate | 5.31 |
| Linalool | 4.1 |
| Nonanal | 4.1 |
| Decanal | 4.1 |
| α-Pinene | 2.98 |
| Acetophenone | 1.2 |
| Indole | 0.73 |
| DPG (solvent) | 13.11 |
| Total content | 100 |

Sensory evaluations were performed on 20 normal male and female adults from 20 to 45 years old. In this case, the sensory evaluations were performed by comparing the aroma of each of Samples E, F, G, and H of the combined fragrances with the aroma of each of Sample A, B, C, and D of the pollen of Citrus unshiu, Citrus natsudaidai, Citrus sudachi, and Fortunella japonica. To avoid after-sensation paralysis, the sensory evaluation was performed on each of the samples at an interval of 5 minutes. The 20 normal male and female adults participating in the sensory evaluation were allowed to fill in a questionnaire as listed in the following Table 9 in order to check the similarity (Question 1) with the aroma and the aroma palatability (Question 2) of Samples A and B. The results are listed in Table 10.

TABLE 9
Questionnaire

(1) Question 1: How similar the aromas of Samples A and B are?

1) Not similar at all.
2) Not particularly similar.
3) Not so good.
4) Somewhat similar.
5) Very similar.

(2) Question 2: How much do you like the aroma of Sample B?

1) Don't like the aroma at all.
2) Don't particularly like the aroma.
3) Not so good.
4) Like the aroma a little.
5) Like the aroma very much.

TABLE 10

| | | | Citrus | | | | Fortunella | |
|---|---|---|---|---|---|---|---|---|
| | Citrus unshiu | | natsudaidai | | Citrus sudachi | | japonica | |
| Test | Question | Question | Question | Question | Question | Question | Question | Question |
| personnel | 1 | 2 | 1 | 2 | 1 | 2 | 1 | 2 |
| 1 | 2 | 2 | 3 | 1 | 1 | 2 | 3 | 2 |
| 2 | 2 | 3 | 2 | 2 | 2 | 2 | 1 | 1 |
| 3 | 2 | 2 | 2 | 2 | 2 | 2 | 2 | 2 |
| 4 | 3 | 3 | 4 | 1 | 3 | 3 | 3 | 3 |
| 5 | 2 | 3 | 2 | 3 | 2 | 3 | 2 | 3 |
| 6 | 3 | 1 | 3 | 2 | 3 | 2 | 3 | 4 |
| 7 | 2 | 3 | 2 | 3 | 2 | 3 | 2 | 2 |
| 8 | 3 | 2 | 3 | 2 | 3 | 2 | 3 | 2 |
| 9 | 2 | 2 | 2 | 2 | 2 | 2 | 2 | 2 |
| 10 | 2 | 1 | 1 | 1 | 1 | 1 | 1 | 1 |
| 11 | 2 | 3 | 2 | 3 | 2 | 3 | 2 | 3 |
| 12 | 2 | 2 | 2 | 2 | 1 | 2 | 2 | 2 |
| 13 | 3 | 2 | 3 | 2 | 3 | 2 | 3 | 2 |
| 14 | 2 | 4 | 2 | 4 | 2 | 1 | 2 | 4 |
| 15 | 3 | 2 | 3 | 2 | 3 | 2 | 3 | 2 |
| 16 | 3 | 3 | 3 | 3 | 3 | 3 | 3 | 3 |
| 17 | 2 | 3 | 2 | 3 | 2 | 3 | 2 | 3 |
| 18 | 1 | 4 | 1 | 4 | 1 | 3 | 1 | 4 |
| 19 | 3 | 2 | 3 | 2 | 3 | 2 | 3 | 2 |
| 20 | 2 | 1 | 2 | 1 | 2 | 1 | 2 | 1 |
| Average | 2.3 | 2.4 | 2.35 | 2.25 | 2.15 | 2.2 | 2.25 | 2.4 |

As listed in Table 10, it was revealed that Samples E, F, G, and H of the combined fragrances had aromas different from those of Sample A, B, C, and D of the pollen of Citrus unshiu, Citrus natsudaidai, Citrus sudachi, and Fortunella japonica, and also had poor palatability.

### [Reference Example 3] Analysis of Aroma and Comparison of Aroma with Citrus Flowers by Expert Evaluation Group

The fragrance composition composed of the components analyzed by the SPME method in Reference Example 1 had low aroma similarity with each of the Citrus flowers, as described in Reference Example 2. Accordingly, an expert evaluation group composed of perfumers performed sensory evaluations on the aromatic components of each of Citrus unshiu, Citrus natsudaidai, Citrus sudachi, and Fortunella japonica. As result, it was confirmed that, among the aromatic components of the flowers of Citrus unshiu and Citrus natsudaidai, the four components, for example, linalool having a floral woody aroma, myrcene having a sweet balsamic and refreshing aroma, nerolidol having a green floral aroma, and methyl anthranilate having a musky fruity aroma, were the main components having the inherent aromas of Citrus unshiu and Citrus natsudaidai.

Also, it was confirmed that, among the aromatic components of the flowers of Citrus sudachi, the four components, for example, linalool having a floral woody aroma, myrcene having a sweet balsamic and refreshing aroma, geraniol having a sweet floral aroma, and β-ocimene having a warm herbaceous aroma, were the main components having the inherent aromas of Citrus sudachi, and that, among the aromatic components of the flowers of Fortunella japonica, the five components, for example, β-ocimene having a warm herbaceous aroma, 6-methyl-5-hepten-2-one having a green herbaceous aroma, anthranilaldehyde having a heavy sweet aroma, limonene having a light sweet citrusy aroma, and methyl anthranilate having a musky fruity aroma, were the main components having the inherent aromas of Fortunella japonica.

### [Example 1] Preparation of Novel Combined Fragrances Depending on Change in Contents of Main Components

From the results of Reference Example 3, it can be seen that the main components of the inherent aroma of Citrus unshiu and Citrus natsudaidai were linalool, myrcene, nerolidol, and methyl anthranilate, the main components of the inherent aroma of Citrus sudachi were linalool, myrcene, geraniol, and β-ocimene, and the main components of the inherent aroma of Fortunella japonica were β-ocimene, 6-methyl-5-hepten-2-one, anthranilaldehyde, limonene, and methyl anthranilate. Therefore, the present inventors prepared the following novel combined fragrances of #A1 to A4, #B1 to #B4, #C1 to #C4, and #D1 to #D4 (indicated by #A to #D) in order to prepare fragrances which included such components to produce the aroma of Citrus unshiu, Citrus natsudaidai, Citrus sudachi, and Fortunella japonica and have good palatability. The combined fragrances #A1 to A4, #B1 to #B4, #C1 to #C4, and #D1 to #D4 were prepared by adding a varying fragrance content (from 60 to 90% by weight) of the main components while maintaining a constant relative ratio of the main aromatic components of these flowers of Citrus unshiu, Citrus natsudaidai, Citrus sudachi, and Fortunella japonica (see the following Tables 11 to 14).

TABLE 11

| | #A1 | #A2 | #A3 | #A4 |
|---|---|---|---|---|
| Fragrance names of | (60% by | (70% by | (80% by | (90% by |
| Citrus unshiu | weight) | weight) | weight) | weight) |
| Linalool | 48.7 | 56.9 | 65.0 | 73.1 |
| Myrcene | 4.1 | 4.8 | 5.4 | 6.1 |
| Nerolidol | 3.7 | 4.4 | 5.0 | 5.6 |
| Methyl anthranilate | 3.4 | 4.0 | 4.6 | 5.1 |
| Anthranilaldehyde | 9.8 | 7.2 | 4.9 | 2.6 |
| 3,7-Dimethyl-1,5- | 8.9 | 6.7 | 4.4 | 2.2 |
| octadiene-3,7-diol | | | | |
| Phenylacetonitrile | 6.9 | 5.2 | 3.5 | 1.7 |
| 6-Methyl-5-hepten-2-one | 4.6 | 3.5 | 2.3 | 1.2 |
| Phenylethyl alcohol | 3.7 | 2.7 | 1.8 | 0.9 |
| Limonene | 3.3 | 2.4 | 1.6 | 0.8 |
| Indole | 2.9 | 2.2 | 1.5 | 0.7 |
| Total content | 100.0 | 100.0 | 100.0 | 100.0 |

TABLE 12

| | #B1 | #B2 | #B3 | #B4 |
|---|---|---|---|---|
| Fragrance names of | (60% by | (70% by | (80% by | (90% by |
| Citrus natsudaidai | weight) | weight) | weight) | weight) |
| Linalool | 36.4 | 42.4 | 48.5 | 54.5 |
| Methyl anthranilate | 13.5 | 15.8 | 18.0 | 20.3 |
| Nerolidol | 6.8 | 8.0 | 9.1 | 10.2 |
| Myrcene | 3.3 | 3.8 | 4.4 | 4.9 |
| Phenylethyl alcohol | 10.8 | 8.1 | 5.4 | 2.7 |
| Phenylacetonitrile | 8.5 | 6.3 | 4.2 | 2.1 |
| 6-Methyl-5-hepten-2-one | 5.5 | 4.1 | 2.7 | 1.5 |
| 3,7-Dimethyl-1,5- | 4.6 | 3.4 | 2.3 | 1.1 |
| octadiene-3,7-diol | | | | |
| Limonene | 4.0 | 3.0 | 2.0 | 1.0 |
| Anthranilaldehyde | 3.6 | 2.7 | 1.8 | 0.9 |
| Indole | 3 | 2.4 | 1.6 | 0.8 |
| Total content | 100.0 | 100.0 | 100.0 | 100.0 |

TABLE 13

| | #C1 | #C2 | #C3 | #C4 |
|---|---|---|---|---|
| Fragrance names of | (60% by | (70% by | (80% by | (90% by |
| Citrus sudachi | weight) | weight) | weight) | weight) |
| Linalool | 43.7 | 50.9 | 58.2 | 65.5 |
| Myrcene | 9.2 | 10.8 | 12.3 | 13.8 |
| Geraniol | 3.9 | 4.5 | 5.1 | 5.8 |
| β-Ocimene | 3.3 | 3.8 | 4.3 | 4.9 |
| 3,7-Dimethyl-1,5- | 8.8 | 6.6 | 4.4 | 2.2 |
| octadiene-3,7-diol | | | | |
| Phenylethyl alcohol | 7.0 | 5.2 | 3.5 | 1.7 |
| Phenylacetonitrile | 6.5 | 4.9 | 3.3 | 1.6 |
| β-Caryophyllene | 6.2 | 4.6 | 3.1 | 1.5 |
| Limonene | 4.3 | 3.2 | 2.1 | 1.1 |
| 6-Methyl-5-hepten-2-one | 2.7 | 2.1 | 1.5 | 0.8 |
| Nonanal | 2.3 | 1.8 | 1.2 | 0.6 |
| Indole | 2.2 | 1.6 | 1.0 | 0.5 |
| Total content | 100.0 | 100.0 | 100.0 | 100.0 |

TABLE 14

| | #D1 | #D2 | #D3 | #D4 |
|---|---|---|---|---|
| Fragrance names of | (60% by | (70% by | (80% by | (90% by |
| Fortunella japonica | weight) | weight) | weight) | weight) |
| β-Ocimene | 18.7 | 21.9 | 25.0 | 28.1 |
| 6-Methyl-5-hepten-2-one | 11.3 | 13.1 | 15.0 | 16.9 |
| Anthranilaldehyde | 10.0 | 11.7 | 13.3 | 15.0 |
| Limonene | 10.0 | 11.7 | 13.3 | 15.0 |
| Methyl anthranilate | 10.0 | 11.7 | 13.3 | 15.0 |
| Ethyl acetate | 9.4 | 7.1 | 4.7 | 2.4 |
| Linalool | 7.3 | 5.4 | 3.7 | 1.8 |
| Nonanal | 7.3 | 5.4 | 3.7 | 1.8 |
| Decanal | 7.3 | 5.4 | 3.7 | 1.8 |
| α-Pinene | 5.3 | 4.0 | 2.6 | 1.3 |
| Acetophenone | 2.1 | 1.6 | 1.1 | 0.6 |
| Indole | 1.3 | 1.0 | 0.6 | 0.3 |
| Total content | 100.0 | 100.0 | 100.0 | 100.0 |

### [Example 2] Sensory Evaluation of Novel Combined Fragrances Prepared in Example 1

Sensory evaluations were performed on the newly combined fragrances #A1 to A4, #B1 to #B4, #C1 to #C4, and #D1 to #D4 prepared in Example 1 in the same manner as in Reference Example 2 to determine the similarity with the aroma of Citrus unshiu, Citrus natsudaidai, Citrus sudachi, and Fortunella japonica and the palatability of the combined fragrances. Meanwhile, after comparative sensory evaluations were performed on the two combined fragrances, test participants were given 5-minute breaks to avoid after-sensation paralysis. The sensory evaluations on the similarity of the novel combined fragrances with the aroma of Citrus unshiu, Citrus natsudaidai, Citrus sudachi, and Fortunella japonica and the palatability of the novel combined fragrances were carried out. The results are listed in the following Tables 15 to 18.

TABLE 15

| | Question 1 (similarity) | | | | Question 2 (palatability) | | | |
|---|---|---|---|---|---|---|---|---|
| | Number of combined fragrance of | | | | Number of combined fragrance of | | | |
| Test | Citrus unshiu | | | | Citrus unshiu | | | |
| personnel | # A1 | # A2 | # A3 | # A4 | # A1 | # A2 | # A3 | # A4 |
| 1 | 3.0 | 3.0 | 3.0 | 3.0 | 2.0 | 3.0 | 3.0 | 3.0 |
| 2 | 2.0 | 3.0 | 3.0 | 2.0 | 2.0 | 4.0 | 4.0 | 3.0 |
| 3 | 3.0 | 3.0 | 4.0 | 3.0 | 3.0 | 3.0 | 4.0 | 3.0 |
| 4 | 2.0 | 3.0 | 3.0 | 3.0 | 2.0 | 2.0 | 3.0 | 2.0 |
| 5 | 3.0 | 3.0 | 3.0 | 2.0 | 2.0 | 3.0 | 4.0 | 3.0 |
| 6 | 3.0 | 4.0 | 3.0 | 3.0 | 2.0 | 2.0 | 3.0 | 2.0 |
| 7 | 2.0 | 3.0 | 4.0 | 4.0 | 3.0 | 3.0 | 4.0 | 3.0 |
| 8 | 2.0 | 3.0 | 3.0 | 3.0 | 3.0 | 3.0 | 3.0 | 3.0 |
| 9 | 3.0 | 3.0 | 4.0 | 3.0 | 3.0 | 3.0 | 3.0 | 3.0 |
| 10 | 2.0 | 2.0 | 3.0 | 2.0 | 2.0 | 2.0 | 3.0 | 2.0 |
| 11 | 2.0 | 2.0 | 4.0 | 3.0 | 3.0 | 3.0 | 4.0 | 2.0 |
| 12 | 1.0 | 3.0 | 3.0 | 2.0 | 3.0 | 2.0 | 3.0 | 4.0 |
| 13 | 2.0 | 2.0 | 4.0 | 3.0 | 2.0 | 3.0 | 4.0 | 3.0 |
| 14 | 2.0 | 3.0 | 3.0 | 2.0 | 3.0 | 3.0 | 3.0 | 3.0 |
| 15 | 3.0 | 3.0 | 3.0 | 3.0 | 3.0 | 3.0 | 4.0 | 3.0 |
| 16 | 2.0 | 2.0 | 4.0 | 3.0 | 2.0 | 2.0 | 3.0 | 2.0 |
| 17 | 1.0 | 3.0 | 3.0 | 3.0 | 3.0 | 4.0 | 4.0 | 3.0 |
| 18 | 1.0 | 2.0 | 3.0 | 2.0 | 1.0 | 2.0 | 3.0 | 2.0 |
| 19 | 3.0 | 3.0 | 3.0 | 2.0 | 2.0 | 3.0 | 3.0 | 3.0 |
| 20 | 2.0 | 3.0 | 3.0 | 3.0 | 3.0 | 3.0 | 2.0 | 3.0 |
| Average | 2.2 | 2.8 | 3.3 | 2.7 | 2.45 | 2.8 | 3.35 | 2.75 |

TABLE 16

| | Question 1 (similarity) | | | | Question 2 (palatability) | | | |
|---|---|---|---|---|---|---|---|---|
| | Number of combined fragrance of | | | | Number of combined fragrance of | | | |
| Test | Citrus natsudaidai | | | | Citrus natsudaidai | | | |
| personnel | # B1 | # B2 | # B3 | # B4 | # B1 | # B2 | # B3 | # B4 |
| 1 | 1.0 | 2.0 | 3.0 | 4.0 | 1.0 | 2.0 | 2.0 | 3.0 |
| 2 | 2.0 | 2.0 | 3.0 | 3.0 | 2.0 | 3.0 | 3.0 | 4.0 |
| 3 | 1.0 | 2.0 | 3.0 | 4.0 | 3.0 | 3.0 | 3.0 | 4.0 |
| 4 | 1.0 | 3.0 | 3.0 | 3.0 | 2.0 | 2.0 | 3.0 | 3.0 |
| 5 | 3.0 | 3.0 | 3.0 | 3.0 | 2.0 | 3.0 | 3.0 | 4.0 |
| 6 | 3.0 | 3.0 | 3.0 | 3.0 | 2.0 | 2.0 | 2.0 | 3.0 |
| 7 | 2.0 | 3.0 | 3.0 | 4.0 | 3.0 | 3.0 | 3.0 | 4.0 |
| 8 | 2.0 | 3.0 | 3.0 | 3.0 | 3.0 | 3.0 | 3.0 | 3.0 |
| 9 | 2.0 | 3.0 | 3.0 | 4.0 | 2.0 | 3.0 | 3.0 | 3.0 |
| 10 | 2.0 | 2.0 | 3.0 | 3.0 | 1.0 | 2.0 | 2.0 | 3.0 |
| 11 | 2.0 | 2.0 | 3.0 | 4.0 | 2.0 | 3.0 | 3.0 | 4.0 |
| 12 | 1.0 | 3.0 | 3.0 | 3.0 | 2.0 | 2.0 | 4.0 | 3.0 |
| 13 | 2.0 | 2.0 | 3.0 | 4.0 | 2.0 | 3.0 | 3.0 | 4.0 |
| 14 | 2.0 | 3.0 | 3.0 | 3.0 | 3.0 | 3.0 | 3.0 | 3.0 |
| 15 | 1.0 | 3.0 | 3.0 | 3.0 | 3.0 | 3.0 | 3.0 | 3.0 |
| 16 | 2.0 | 2.0 | 2.0 | 4.0 | 2.0 | 2.0 | 4.0 | 3.0 |
| 17 | 1.0 | 2.0 | 2.0 | 3.0 | 3.0 | 3.0 | 3.0 | 4.0 |
| 18 | 1.0 | 1.0 | 1.0 | 2.0 | 1.0 | 2.0 | 2.0 | 3.0 |
| 19 | 3.0 | 3.0 | 3.0 | 3.0 | 2.0 | 3.0 | 3.0 | 4.0 |
| 20 | 1.0 | 3.0 | 3.0 | 3.0 | 2.0 | 2.0 | 2.0 | 4.0 |
| Average | 1.75 | 2.5 | 2.8 | 3.3 | 2.15 | 2.6 | 2.85 | 3.45 |

TABLE 17

| | Question 1 (similarity) | | | | Question 2 (palatability) | | | |
|---|---|---|---|---|---|---|---|---|
| | Number of combined fragrance of | | | | Number of combined fragrance of | | | |
| Test | Citrus sudachi | | | | Citrus sudachi | | | |
| personnel | # C1 | # C2 | # C3 | # C4 | # C1 | # C2 | # C3 | # C4 |
| 1 | 3.0 | 3.0 | 3.0 | 3.0 | 2.0 | 3.0 | 3.0 | 3.0 |
| 2 | 2.0 | 3.0 | 3.0 | 2.0 | 2.0 | 4.0 | 4.0 | 3.0 |
| 3 | 3.0 | 3.0 | 4.0 | 3.0 | 3.0 | 3.0 | 4.0 | 3.0 |
| 4 | 2.0 | 3.0 | 3.0 | 3.0 | 2.0 | 2.0 | 3.0 | 2.0 |
| 5 | 3.0 | 3.0 | 3.0 | 2.0 | 2.0 | 3.0 | 4.0 | 3.0 |
| 6 | 3.0 | 4.0 | 3.0 | 3.0 | 2.0 | 2.0 | 3.0 | 2.0 |
| 7 | 2.0 | 3.0 | 4.0 | 4.0 | 3.0 | 3.0 | 4.0 | 3.0 |
| 8 | 2.0 | 3.0 | 3.0 | 3.0 | 3.0 | 3.0 | 3.0 | 3.0 |
| 9 | 3.0 | 3.0 | 4.0 | 3.0 | 3.0 | 3.0 | 3.0 | 3.0 |
| 10 | 2.0 | 2.0 | 3.0 | 2.0 | 2.0 | 2.0 | 3.0 | 2.0 |
| 11 | 2.0 | 2.0 | 4.0 | 3.0 | 3.0 | 3.0 | 4.0 | 2.0 |
| 12 | 1.0 | 3.0 | 3.0 | 2.0 | 3.0 | 2.0 | 3.0 | 4.0 |
| 13 | 2.0 | 2.0 | 4.0 | 3.0 | 2.0 | 3.0 | 4.0 | 3.0 |
| 14 | 2.0 | 3.0 | 3.0 | 2.0 | 3.0 | 3.0 | 3.0 | 2.0 |
| 15 | 3.0 | 3.0 | 3.0 | 3.0 | 3.0 | 3.0 | 3.0 | 3.0 |
| 16 | 2.0 | 2.0 | 4.0 | 3.0 | 2.0 | 2.0 | 3.0 | 2.0 |
| 17 | 1.0 | 3.0 | 3.0 | 3.0 | 3.0 | 4.0 | 4.0 | 3.0 |
| 18 | 1.0 | 1.0 | 2.0 | 2.0 | 1.0 | 2.0 | 3.0 | 2.0 |
| 19 | 3.0 | 3.0 | 3.0 | 2.0 | 2.0 | 3.0 | 3.0 | 3.0 |
| 20 | 2.0 | 3.0 | 3.0 | 3.0 | 3.0 | 3.0 | 2.0 | 3.0 |
| Average | 2.2 | 2.75 | 3.25 | 2.7 | 2.45 | 2.8 | 3.3 | 2.7 |

TABLE 18

| | Question 1 (similarity) | | | | Question 2 (palatability) | | | |
|---|---|---|---|---|---|---|---|---|
| | Number of combined fragrance of | | | | Number of combined fragrance of | | | |
| Test | Fortunella japonica | | | | Fortunella japonica | | | |
| personnel | # D1 | # D2 | # D3 | # D4 | # D1 | # D2 | # D3 | # D4 |
| 1 | 3.0 | 4.0 | 2.0 | 1.0 | 2.0 | 4.0 | 2.0 | 2.0 |
| 2 | 2.0 | 3.0 | 3.0 | 2.0 | 2.0 | 3.0 | 3.0 | 1.0 |
| 3 | 1.0 | 4.0 | 3.0 | 1.0 | 3.0 | 3.0 | 3.0 | 1.0 |
| 4 | 2.0 | 3.0 | 3.0 | 2.0 | 2.0 | 4.0 | 3.0 | 3.0 |
| 5 | 3.0 | 3.0 | 4.0 | 2.0 | 2.0 | 3.0 | 3.0 | 1.0 |
| 6 | 3.0 | 3.0 | 2.0 | 2.0 | 2.0 | 3.0 | 2.0 | 3.0 |
| 7 | 2.0 | 3.0 | 3.0 | 1.0 | 3.0 | 3.0 | 3.0 | 1.0 |
| 8 | 2.0 | 3.0 | 2.0 | 2.0 | 3.0 | 3.0 | 4.0 | 3.0 |
| 9 | 3.0 | 3.0 | 3.0 | 2.0 | 2.0 | 3.0 | 3.0 | 3.0 |
| 10 | 2.0 | 4.0 | 3.0 | 3.0 | 1.0 | 4.0 | 2.0 | 2.0 |
| 11 | 2.0 | 3.0 | 3.0 | 1.0 | 2.0 | 3.0 | 3.0 | 1.0 |
| 12 | 1.0 | 3.0 | 3.0 | 3.0 | 2.0 | 3.0 | 4.0 | 3.0 |
| 13 | 2.0 | 4.0 | 3.0 | 1.0 | 2.0 | 3.0 | 3.0 | 2.0 |
| 14 | 2.0 | 3.0 | 3.0 | 2.0 | 3.0 | 3.0 | 3.0 | 3.0 |
| 15 | 3.0 | 3.0 | 3.0 | 3.0 | 3.0 | 3.0 | 3.0 | 3.0 |
| 16 | 2.0 | 3.0 | 2.0 | 1.0 | 2.0 | 4.0 | 3.0 | 3.0 |
| 17 | 2.0 | 3.0 | 2.0 | 1.0 | 3.0 | 3.0 | 1.0 | 1.0 |
| 18 | 2.0 | 4.0 | 2.0 | 2.0 | 1.0 | 3.0 | 2.0 | 3.0 |
| 19 | 3.0 | 3.0 | 4.0 | 3.0 | 2.0 | 3.0 | 3.0 | 1.0 |
| 20 | 3.0 | 4.0 | 3.0 | 2.0 | 2.0 | 3.0 | 2.0 | 1.0 |
| Average | 2.25 | 3.3 | 2.8 | 1.85 | 2.2 | 3.2 | 2.75 | 2.05 |

As listed in Tables 15 to 18, it was revealed that Samples #A3 and #C3 in which the total content of the four components accounted for 80% by weight in the case of Citrus unshiu and Citrus sudachi had the highest similarity and palatability with respect to the respective combined fragrances, Sample #B4 in which the total content of the four components accounted for 90% by weight in the case of Citrus natsudaidai had the highest similarity and palatability with respect to the respective combined fragrances, and Sample #D2 in which the total content of the five components accounted for 70% by weight in the case of Fortunella japonica had the highest similarity and palatability with respect to the respective combined fragrances, but both of the similarity and palatability were observed to fall short of expectations.

### [Example 3] Preparation of Aroma-Improved Fragrances Based on Analysis by Expert Evaluation Group

To improve the similarity and palatability of the fragrances of Samples #A3, #B4, #C3, and #D2 analyzed to be most similar to the aroma of Citrus unshiu, Citrus natsudaidai, Citrus sudachi, and Fortunella japonica as listed in Table 15 to 18, a novel combined fragrance including linalool, myrcene, nerolidol, and methyl anthranilate at a content of 80% by weight as in Sample #A3 and further including jasmone having a unique flavor in reproducing the aroma of Citrus unshiu was prepared, and a novel combined fragrance including linalool, methyl anthranilate, nerolidol, and myrcene at a content of 90% by weight as in Sample #B4 and further including β-caryophyllene having a unique flavor in reproducing the aroma of Citrus natsudaidai was prepared.

Also, a novel combined fragrance including linalool, myrcene, geraniol, and β-ocimene at a content of 80% by weight as in Sample #C3 and further including γ-terpinene having a unique flavor in reproducing the aroma of Citrus sudachi was prepared, and a novel combined fragrance including β-ocimene, 6-methyl-5-hepten-2-one, anthranilaldehyde, limonene, and methyl anthranilate at a content of 70% by weight as in Sample #D2 and further including α-farnesene having a unique flavor in reproducing the aroma of Fortunella japonica was prepared.

In this case, each of the aromatic components such as jasmone, β-caryophyllene, γ-terpinene, and α-farnesene was added at an increasing content of 0.9% by weight, 1.5% by weight, 2.1% by weight, 2.7% by weight, 3.3% by weight, 3.9% by weight, and 4.5% by weight. The criteria for the contents of the aromatic components were determined through the evaluation by a group of expert perfumers. The compositions of such novel combined fragrances are as listed in the following Tables 19 to 22.

TABLE 19

| | Number of combined fragrance | | | | | | |
|---|---|---|---|---|---|---|---|
| | # AA | # BB | # CC | # DD | # EE | # FF | # GG |
| Fragrance names of | Content | Content | Content | Content | Content | Content | Content |
| Citrus unshiu | (%) | (%) | (%) | (%) | (%) | (%) | (%) |
| Linalool | 65.0 | 65.0 | 65.0 | 65.0 | 65.0 | 65.0 | 65.0 |
| Myrcene | 5.4 | 5.4 | 5.4 | 5.4 | 5.4 | 5.4 | 5.4 |
| Nerolidol | 5.0 | 5.0 | 5.0 | 5.0 | 5.0 | 5.0 | 5.0 |
| Methyl anthranilate | 4.6 | 4.6 | 4.6 | 4.6 | 4.6 | 4.6 | 4.6 |
| Anthranilaldehyde | 4.4 | 4.3 | 4.3 | 4.2 | 4.2 | 4.0 | 4.0 |
| 3,7-Dimethyl-1,5- | 4.2 | 4.0 | 3.9 | 3.8 | 3.8 | 3.8 | 3.3 |
| octadiene-3,7-diol | | | | | | | |
| Phenylacetonitrile | 3.4 | 3.3 | 3.2 | 3.2 | 3.0 | 2.9 | 2.9 |
| 6-Methyl-5-hepten-2- | 2.2 | 2.1 | 2.0 | 1.9 | 1.9 | 1.8 | 1.8 |
| one | | | | | | | |
| Phenylethyl alcohol | 1.8 | 1.7 | 1.7 | 1.7 | 1.6 | 1.6 | 1.6 |
| Limonene | 1.6 | 1.6 | 1.5 | 1.4 | 1.3 | 1.3 | 1.3 |
| Indole | 1.5 | 1.5 | 1.3 | 1.1 | 0.9 | 0.7 | 0.6 |
| Jasmone | 0.9 | 1.5 | 2.1 | 2.7 | 3.3 | 3.9 | 4.5 |
| Total content | 100.0 | 100.0 | 100.0 | 100.0 | 100.0 | 100.0 | 100.0 |

TABLE 20

| | Number of combined fragrance | | | | | | |
|---|---|---|---|---|---|---|---|
| | # AA | # BB | # CC | # DD | # EE | # FF | # GG |
| Fragrance names of | Content | Content | Content | Content | Content | Content | Content |
| Citrus natsudaidai | (%) | (%) | (%) | (%) | (%) | (%) | (%) |
| Linalool | 54.5 | 54.5 | 54.5 | 54.5 | 54.5 | 54.5 | 54.5 |
| Methyl anthranilate | 20.3 | 20.3 | 20.3 | 20.3 | 20.3 | 20.3 | 20.3 |
| Nerolidol | 10.2 | 10.2 | 10.2 | 10.2 | 10.2 | 10.2 | 10.2 |
| Myrcene | 4.9 | 4.9 | 4.9 | 4.9 | 4.9 | 4.9 | 4.9 |
| Phenylethyl alcohol | 2.5 | 2.3 | 2.2 | 2.0 | 2.0 | 2.0 | 1.4 |
| Phenylacetonitrile | 1.9 | 1.7 | 1.6 | 1.4 | 1.4 | 1.2 | 1.2 |
| 6-Methyl-5-hepten-2- | 1.4 | 1.2 | 1.2 | 1.0 | 1.0 | 0.8 | 0.8 |
| one | | | | | | | |
| 3,7-Dimethyl-1,5- | 1.0 | 1.0 | 0.9 | 0.9 | 0.9 | 0.7 | 0.7 |
| octadiene-3,7-diol | | | | | | | |
| Limonene | 0.9 | 0.9 | 0.8 | 0.8 | 0.6 | 0.6 | 0.6 |
| Anthranilaldehyde | 0.8 | 0.8 | 0.7 | 0.7 | 0.5 | 0.5 | 0.5 |
| Indole | 0.7 | 0.7 | 0.6 | 0.6 | 0.4 | 0.4 | 0.4 |
| β-Caryophyllene | 0.9 | 1.5 | 2.1 | 2.7 | 3.3 | 3.9 | 4.5 |
| Total content | 100.0 | 100.0 | 100.0 | 100.0 | 100.0 | 100.0 | 100.0 |

TABLE 21

| | Number of combined fragrance | | | | | | |
|---|---|---|---|---|---|---|---|
| | # AA | # BB | # CC | # DD | # EE | # FF | # GG |
| Fragrance names of | Content | Content | Content | Content | Content | Content | Content |
| Citrus sudachi | (%) | (%) | (%) | (%) | (%) | (%) | (%) |
| Linalool | 58.2 | 58.2 | 58.2 | 58.2 | 58.2 | 58.2 | 58.2 |
| Myrcene | 12.3 | 12.3 | 12.3 | 12.3 | 12.3 | 12.3 | 12.3 |
| Geraniol | 5.1 | 5.1 | 5.1 | 5.1 | 5.1 | 5.1 | 5.1 |
| β-Ocimene | 4.3 | 4.3 | 4.3 | 4.3 | 4.3 | 4.3 | 4.3 |
| 3,7-Dimethyl-1,5- | 4.1 | 4.1 | 4.0 | 3.9 | 3.8 | 3.8 | 3.5 |
| octadiene-3,7-diol | | | | | | | |
| Phenylethyl alcohol | 3.2 | 3.2 | 3.2 | 3.1 | 3.0 | 2.9 | 2.8 |
| Phenylacetonitrile | 3.1 | 3.1 | 2.9 | 2.9 | 2.8 | 2.6 | 2.5 |
| β-Caryophyllene | 3.0 | 2.9 | 2.7 | 2.7 | 2.6 | 2.4 | 2.3 |
| Limonene | 2.1 | 1.9 | 1.9 | 1.8 | 1.8 | 1.8 | 1.8 |
| 6-Methyl-5-hepten-2- | 1.5 | 1.4 | 1.4 | 1.3 | 1.3 | 1.3 | 1.3 |
| one | | | | | | | |
| Nonanal | 1.2 | 1.1 | 1.1 | 1.0 | 0.9 | 0.9 | 0.9 |
| Indole | 1.0 | 0.9 | 0.8 | 0.7 | 0.6 | 0.5 | 0.5 |
| γ-Terpinene | 0.9 | 1.5 | 2.1 | 2.7 | 3.3 | 3.9 | 4.5 |
| Total content | 100.0 | 100.0 | 100.0 | 100.0 | 100.0 | 100.0 | 100.0 |

TABLE 22

| | Number of combined fragrance | | | | | | |
|---|---|---|---|---|---|---|---|
| | # AA | # BB | # CC | # DD | # EE | # FF | # GG |
| Fragrance names of | Content | Content | Content | Content | Content | Content | Content |
| Fortunella japonica | (%) | (%) | (%) | (%) | (%) | (%) | (%) |
| β-Ocimene | 21.9 | 21.9 | 21.9 | 21.9 | 21.9 | 21.9 | 21.9 |
| 6-Methyl-5-hepten-2- | 13.1 | 13.1 | 13.1 | 13.1 | 13.1 | 13.1 | 13.1 |
| one | | | | | | | |
| Anthranilaldehyde | 11.7 | 11.7 | 11.7 | 11.7 | 11.7 | 11.7 | 11.7 |
| Limonene | 11.7 | 11.7 | 11.7 | 11.7 | 11.7 | 11.7 | 11.7 |
| Methyl anthranilate | 11.7 | 11.7 | 11.7 | 11.7 | 11.7 | 11.7 | 11.7 |
| Ethyl acetate | 7.0 | 7.0 | 6.8 | 6.6 | 6.6 | 6.6 | 6.3 |
| Linalool | 5.2 | 5.1 | 5.1 | 5.0 | 5.0 | 4.9 | 4.9 |
| Nonanal | 5.2 | 5.1 | 5.1 | 5.0 | 5.0 | 4.9 | 4.9 |
| Decanal | 5.2 | 5.1 | 5.1 | 5.0 | 5.0 | 4.9 | 4.9 |
| α-Pinene | 3.9 | 3.9 | 3.8 | 3.7 | 3.5 | 3.5 | 3.4 |
| Acetophenone | 1.5 | 1.3 | 1.1 | 1.1 | 0.9 | 0.7 | 0.7 |
| Indole | 1.0 | 0.9 | 0.8 | 0.8 | 0.6 | 0.5 | 0.3 |
| α-Famesene | 0.9 | 1.5 | 2.1 | 2.7 | 3.3 | 3.9 | 4.5 |
| Total content | 100.0 | 100.0 | 100.0 | 100.0 | 100.0 | 100.0 | 100.0 |

### [Example 4] Sensory Evaluation of Combined Fragrances Prepared in Example 3

Sensory evaluations were performed on the combined fragrances #AA, #BB, #CC, #DD, #EE, #FF, and #GG in the same manner as in Reference Example 2 to determine the similarity with the aroma of Citrus unshiu, Citrus natsudaidai, Citrus sudachi, and Fortunella japonica and the palatability of the combined fragrances. After comparative sensory evaluations were performed on the two combined fragrances, test participants were given 5-minute breaks to avoid after-sensation paralysis. The results of the similarity of the novel combined fragrances with the aroma of the Citrus flowers and the aroma palatability of the novel combined fragrances are listed in the following Tables 23 to 26.

TABLE 23

| | Question 1 (similarity) | | | | | | | Question 2 (palatability) | | | | | | |
|---|---|---|---|---|---|---|---|---|---|---|---|---|---|---|
| | Number of combined fragrance of | | | | | | | Number of combined fragrance of | | | | | | |
| Test | Citrus unshiu | | | | | | | Citrus unshiu | | | | | | |
| personnel | # AA | # BB | # CC | # DD | # EE | # FF | # GG | # AA | # BB | # CC | # DD | # EE | # FF | # GG |
| 1 | 3.0 | 4.0 | 4.0 | 4.0 | 4.0 | 3.0 | 3.0 | 3.0 | 3.0 | 3.0 | 4.0 | 4.0 | 4.0 | 3.0 |
| 2 | 2.0 | 4.0 | 4.0 | 5.0 | 3.0 | 3.0 | 3.0 | 3.0 | 4.0 | 4.0 | 4.0 | 5.0 | 4.0 | 2.0 |
| 3 | 3.0 | 3.0 | 3.0 | 4.0 | 4.0 | 4.0 | 3.0 | 3.0 | 3.0 | 3.0 | 4.0 | 4.0 | 3.0 | 3.0 |
| 4 | 3.0 | 3.0 | 3.0 | 4.0 | 4.0 | 3.0 | 3.0 | 3.0 | 3.0 | 3.0 | 4.0 | 4.0 | 3.0 | 3.0 |
| 5 | 4.0 | 4.0 | 4.0 | 5.0 | 4.0 | 4.0 | 4.0 | 4.0 | 4.0 | 4.0 | 3.0 | 5.0 | 4.0 | 3.0 |
| 6 | 3.0 | 3.0 | 3.0 | 4.0 | 4.0 | 3.0 | 3.0 | 3.0 | 3.0 | 4.0 | 4.0 | 5.0 | 5.0 | 3.0 |
| 7 | 3.0 | 3.0 | 4.0 | 3.0 | 5.0 | 4.0 | 4.0 | 3.0 | 4.0 | 3.0 | 4.0 | 4.0 | 3.0 | 3.0 |
| 8 | 3.0 | 4.0 | 4.0 | 4.0 | 4.0 | 3.0 | 3.0 | 2.0 | 3.0 | 3.0 | 4.0 | 5.0 | 4.0 | 2.0 |
| 9 | 2.0 | 2.0 | 3.0 | 3.0 | 4.0 | 4.0 | 3.0 | 3.0 | 4.0 | 3.0 | 4.0 | 5.0 | 4.0 | 3.0 |
| 10 | 3.0 | 3.0 | 3.0 | 4.0 | 4.0 | 4.0 | 3.0 | 2.0 | 3.0 | 4.0 | 3.0 | 4.0 | 3.0 | 3.0 |
| 11 | 2.0 | 4.0 | 4.0 | 4.0 | 4.0 | 5.0 | 4.0 | 4.0 | 3.0 | 4.0 | 4.0 | 5.0 | 4.0 | 2.0 |
| 12 | 3.0 | 3.0 | 3.0 | 4.0 | 5.0 | 4.0 | 3.0 | 3.0 | 4.0 | 4.0 | 4.0 | 5.0 | 5.0 | 4.0 |
| 13 | 2.0 | 4.0 | 4.0 | 4.0 | 5.0 | 3.0 | 3.0 | 3.0 | 3.0 | 4.0 | 5.0 | 5.0 | 4.0 | 4.0 |
| 14 | 3.0 | 3.0 | 3.0 | 5.0 | 5.0 | 4.0 | 3.0 | 3.0 | 4.0 | 5.0 | 4.0 | 4.0 | 4.0 | 3.0 |
| 15 | 4.0 | 3.0 | 3.0 | 3.0 | 4.0 | 4.0 | 3.0 | 3.0 | 3.0 | 3.0 | 4.0 | 5.0 | 4.0 | 4.0 |
| 16 | 3.0 | 4.0 | 4.0 | 4.0 | 4.0 | 5.0 | 3.0 | 2.0 | 3.0 | 4.0 | 5.0 | 4.0 | 4.0 | 3.0 |
| 17 | 2.0 | 3.0 | 3.0 | 4.0 | 5.0 | 4.0 | 2.0 | 3.0 | 4.0 | 3.0 | 4.0 | 4.0 | 4.0 | 3.0 |
| 18 | 4.0 | 3.0 | 4.0 | 4.0 | 4.0 | 5.0 | 3.0 | 3.0 | 4.0 | 4.0 | 4.0 | 5.0 | 5.0 | 2.0 |
| 19 | 3.0 | 3.0 | 3.0 | 3.0 | 4.0 | 4.0 | 3.0 | 2.0 | 3.0 | 3.0 | 3.0 | 4.0 | 3.0 | 3.0 |
| 20 | 2.0 | 3.0 | 4.0 | 4.0 | 5.0 | 4.0 | 3.0 | 2.0 | 3.0 | 3.0 | 4.0 | 5.0 | 4.0 | 2.0 |
| Average | 2.85 | 3.3 | 3.5 | 3.95 | 4.25 | 3.85 | 3.1 | 2.85 | 3.4 | 3.55 | 3.95 | 4.55 | 3.9 | 2.9 |

In the case of Citrus unshiu, it can be seen that, when the combined fragrance further included 1.5 to 3.9% by weight of jasmone in addition to the main aromatic components of Citrus unshiu such as linalool, myrcene, nerolidol, and methyl anthranilate, the combined fragrance was able to be used to reproduce the aroma of Citrus unshiu and had high palatability (3.3 or more in average), as listed in Table 23. In particular, it can be seen that, when the combined fragrance further included 2.7 to 3.9% by weight of jasmone (#DD, #EE, and #FF), the combined fragrance had very high similarity with the aroma of Citrus unshiu and very excellent aroma palatability (3.8 or more in average).

TABLE 24

| | Question 1 (similarity) | | | | | | | Question 2 (palatability) | | | | | | |
|---|---|---|---|---|---|---|---|---|---|---|---|---|---|---|
| | Number of combined fragrance of | | | | | | | Number of combined fragrance of | | | | | | |
| Test | Citrus natsudaidai | | | | | | | Citrus natsudaidai | | | | | | |
| personnel | # AA | # BB | # CC | # DD | # EE | # FF | # GG | # AA | # BB | # CC | # DD | # EE | # FF | # GG |
| 1 | 4.0 | 4.0 | 4.0 | 3.0 | 3.0 | 3.0 | 3.0 | 3.0 | 3.0 | 4.0 | 5.0 | 4.0 | 2.0 | 2.0 |
| 2 | 3.0 | 4.0 | 5.0 | 3.0 | 3.0 | 3.0 | 2.0 | 3.0 | 3.0 | 4.0 | 5.0 | 4.0 | 3.0 | 2.0 |
| 3 | 3.0 | 3.0 | 4.0 | 4.0 | 4.0 | 3.0 | 2.0 | 4.0 | 4.0 | 4.0 | 5.0 | 4.0 | 2.0 | 2.0 |
| 4 | 3.0 | 3.0 | 4.0 | 4.0 | 3.0 | 3.0 | 3.0 | 3.0 | 3.0 | 4.0 | 4.0 | 4.0 | 3.0 | 3.0 |
| 5 | 4.0 | 4.0 | 5.0 | 4.0 | 4.0 | 4.0 | 3.0 | 3.0 | 3.0 | 4.0 | 4.0 | 3.0 | 3.0 | 3.0 |
| 6 | 3.0 | 3.0 | 4.0 | 5.0 | 4.0 | 3.0 | 2.0 | 4.0 | 4.0 | 3.0 | 3.0 | 4.0 | 3.0 | 3.0 |
| 7 | 3.0 | 4.0 | 4.0 | 5.0 | 4.0 | 4.0 | 3.0 | 3.0 | 4.0 | 3.0 | 4.0 | 5.0 | 4.0 | 2.0 |
| 8 | 4.0 | 4.0 | 4.0 | 4.0 | 3.0 | 3.0 | 2.0 | 4.0 | 4.0 | 5.0 | 5.0 | 4.0 | 3.0 | 3.0 |
| 9 | 2.0 | 3.0 | 3.0 | 4.0 | 4.0 | 3.0 | 3.0 | 3.0 | 3.0 | 3.0 | 4.0 | 4.0 | 2.0 | 2.0 |
| 10 | 3.0 | 3.0 | 4.0 | 4.0 | 4.0 | 3.0 | 3.0 | 4.0 | 4.0 | 4.0 | 5.0 | 4.0 | 3.0 | 3.0 |
| 11 | 4.0 | 4.0 | 4.0 | 4.0 | 5.0 | 4.0 | 3.0 | 3.0 | 4.0 | 3.0 | 4.0 | 3.0 | 3.0 | 3.0 |
| 12 | 3.0 | 4.0 | 4.0 | 5.0 | 4.0 | 3.0 | 2.0 | 3.0 | 4.0 | 4.0 | 5.0 | 4.0 | 2.0 | 2.0 |
| 13 | 4.0 | 4.0 | 4.0 | 5.0 | 3.0 | 3.0 | 3.0 | 3.0 | 3.0 | 3.0 | 3.0 | 3.0 | 2.0 | 2.0 |
| 14 | 3.0 | 3.0 | 5.0 | 5.0 | 4.0 | 3.0 | 3.0 | 3.0 | 4.0 | 5.0 | 5.0 | 4.0 | 4.0 | 3.0 |
| 15 | 3.0 | 3.0 | 3.0 | 4.0 | 4.0 | 3.0 | 3.0 | 4.0 | 3.0 | 4.0 | 4.0 | 3.0 | 3.0 | 3.0 |
| 16 | 4.0 | 4.0 | 4.0 | 4.0 | 5.0 | 3.0 | 3.0 | 3.0 | 3.0 | 3.0 | 4.0 | 4.0 | 4.0 | 4.0 |
| 17 | 3.0 | 3.0 | 4.0 | 5.0 | 4.0 | 2.0 | 2.0 | 3.0 | 4.0 | 5.0 | 4.0 | 3.0 | 4.0 | 4.0 |
| 18 | 2.0 | 3.0 | 4.0 | 4.0 | 5.0 | 3.0 | 3.0 | 4.0 | 4.0 | 4.0 | 4.0 | 4.0 | 3.0 | 3.0 |
| 19 | 3.0 | 4.0 | 3.0 | 4.0 | 4.0 | 3.0 | 3.0 | 4.0 | 4.0 | 4.0 | 4.0 | 4.0 | 3.0 | 2.0 |
| 20 | 3.0 | 4.0 | 4.0 | 5.0 | 4.0 | 3.0 | 3.0 | 3.0 | 3.0 | 3.0 | 4.0 | 3.0 | 3.0 | 3.0 |
| Average | 3.2 | 3.55 | 4.0 | 4.25 | 3.9 | 3.1 | 2.7 | 3.35 | 3.55 | 3.8 | 4.25 | 3.75 | 2.95 | 2.7 |

In the case of Citrus natsudaidai, it can be seen that, when the combined fragrance further included 0.9 to 3.9% by weight of β-caryophyllene in addition to the main aromatic components of Citrus natsudaidai such as linalool, methyl anthranilate, nerolidol, and myrcene, the combined fragrance was able to be used to reproduce the aroma of Citrus natsudaidai and had high palatability (2.95 or more in average), as listed in Table 24. In particular, it can be seen that, when the combined fragrance further included 2.1 to 3.3% by weight of β-caryophyllene (#CC, #DD, and #EE), the combined fragrance had very high similarity with the aroma of Citrus natsudaidai and very excellent aroma palatability (3.8 or more in average).

TABLE 25

| | Question 1 (similarity) | | | | | | | Question 2 (palatability) | | | | | | |
|---|---|---|---|---|---|---|---|---|---|---|---|---|---|---|
| | Number of combined fragrance of | | | | | | | Number of combined fragrance of | | | | | | |
| Test | Citrus sudachi | | | | | | | Citrus sudachi | | | | | | |
| personnel | # AA | # BB | # CC | # DD | # EE | # FF | # GG | # AA | # BB | # CC | # DD | # EE | # FF | # GG |
| 1 | 3.0 | 3.0 | 3.0 | 4.0 | 4.0 | 4.0 | 3.0 | 2.0 | 4.0 | 5.0 | 4.0 | 3.0 | 3.0 | 2.0 |
| 2 | 3.0 | 3.0 | 3.0 | 5.0 | 4.0 | 4.0 | 2.0 | 3.0 | 4.0 | 4.0 | 3.0 | 3.0 | 3.0 | 3.0 |
| 3 | 3.0 | 4.0 | 4.0 | 4.0 | 3.0 | 3.0 | 3.0 | 2.0 | 4.0 | 5.0 | 4.0 | 4.0 | 4.0 | 3.0 |
| 4 | 3.0 | 3.0 | 4.0 | 4.0 | 3.0 | 3.0 | 3.0 | 3.0 | 3.0 | 4.0 | 4.0 | 3.0 | 3.0 | 3.0 |
| 5 | 4.0 | 4.0 | 4.0 | 5.0 | 4.0 | 4.0 | 4.0 | 3.0 | 3.0 | 4.0 | 4.0 | 3.0 | 3.0 | 3.0 |
| 6 | 3.0 | 3.0 | 3.0 | 4.0 | 3.0 | 3.0 | 3.0 | 3.0 | 4.0 | 3.0 | 3.0 | 4.0 | 4.0 | 4.0 |
| 7 | 4.0 | 4.0 | 5.0 | 3.0 | 4.0 | 3.0 | 3.0 | 3.0 | 5.0 | 4.0 | 3.0 | 4.0 | 3.0 | 3.0 |
| 8 | 3.0 | 3.0 | 4.0 | 4.0 | 4.0 | 4.0 | 3.0 | 3.0 | 3.0 | 4.0 | 4.0 | 3.0 | 4.0 | 3.0 |
| 9 | 3.0 | 4.0 | 4.0 | 3.0 | 3.0 | 2.0 | 2.0 | 2.0 | 4.0 | 4.0 | 3.0 | 3.0 | 3.0 | 2.0 |
| 10 | 3.0 | 4.0 | 4.0 | 4.0 | 3.0 | 3.0 | 3.0 | 3.0 | 4.0 | 5.0 | 4.0 | 3.0 | 4.0 | 3.0 |
| 11 | 4.0 | 5.0 | 4.0 | 4.0 | 4.0 | 4.0 | 2.0 | 3.0 | 3.0 | 4.0 | 3.0 | 4.0 | 3.0 | 2.0 |
| 12 | 3.0 | 4.0 | 5.0 | 4.0 | 4.0 | 3.0 | 3.0 | 2.0 | 4.0 | 5.0 | 4.0 | 4.0 | 3.0 | 4.0 |
| 13 | 3.0 | 3.0 | 5.0 | 4.0 | 4.0 | 4.0 | 2.0 | 2.0 | 3.0 | 3.0 | 3.0 | 3.0 | 3.0 | 3.0 |
| 14 | 3.0 | 4.0 | 5.0 | 5.0 | 3.0 | 3.0 | 3.0 | 4.0 | 4.0 | 5.0 | 5.0 | 4.0 | 3.0 | 3.0 |
| 15 | 3.0 | 4.0 | 4.0 | 3.0 | 3.0 | 3.0 | 4.0 | 3.0 | 3.0 | 4.0 | 4.0 | 3.0 | 4.0 | 3.0 |
| 16 | 3.0 | 5.0 | 4.0 | 4.0 | 4.0 | 4.0 | 3.0 | 4.0 | 4.0 | 4.0 | 3.0 | 3.0 | 3.0 | 3.0 |
| 17 | 2.0 | 4.0 | 5.0 | 4.0 | 3.0 | 3.0 | 2.0 | 4.0 | 3.0 | 4.0 | 5.0 | 4.0 | 3.0 | 2.0 |
| 18 | 3.0 | 5.0 | 4.0 | 4.0 | 4.0 | 3.0 | 4.0 | 3.0 | 3.0 | 4.0 | 4.0 | 3.0 | 4.0 | 3.0 |
| 19 | 3.0 | 4.0 | 4.0 | 3.0 | 3.0 | 3.0 | 3.0 | 3.0 | 3.0 | 4.0 | 4.0 | 4.0 | 4.0 | 3.0 |
| 20 | 3.0 | 4.0 | 5.0 | 4.0 | 4.0 | 3.0 | 2.0 | 3.0 | 3.0 | 4.0 | 3.0 | 3.0 | 3.0 | 3.0 |
| Average | 3.1 | 3.85 | 4.15 | 3.95 | 3.55 | 3.3 | 2.85 | 2.9 | 3.55 | 4.15 | 3.7 | 3.4 | 3.35 | 2.9 |

In the case of Citrus sudachi, it can be seen that, when the combined fragrance further included 0.9 to 3.9% by weight of γ-terpinene in addition to the main aromatic components of Citrus sudachi such as linalool, myrcene, geraniol, and β-ocimene, the combined fragrance was able to be used to reproduce the aroma of Citrus sudachi and had high palatability (2.9 or more in average), as listed in Table 25. In particular, it can be seen that, when the combined fragrance further included 1.5 to 2.7% by weight of γ-terpinene (#BB, #CC, and #DD), the combined fragrance had very high similarity with the aroma of Citrus sudachi and very excellent aroma palatability (3.55 or more in average).

TABLE 26

| | Question 1 (similarity) | | | | | | | Question 2 (palatability) | | | | | | |
|---|---|---|---|---|---|---|---|---|---|---|---|---|---|---|
| | Number of combined fragrance of | | | | | | | Number of combined fragrance of | | | | | | |
| Test | Fortunella japonica | | | | | | | Fortunella japonica | | | | | | |
| personnel | # AA | # BB | # CC | # DD | # EE | # FF | # GG | # AA | # BB | # CC | # DD | # EE | # FF | # GG |
| 1 | 3.0 | 4.0 | 4.0 | 4.0 | 3.0 | 3.0 | 3.0 | 2.0 | 3.0 | 3.0 | 3.0 | 4.0 | 4.0 | 2.0 |
| 2 | 2.0 | 4.0 | 4.0 | 5.0 | 3.0 | 3.0 | 3.0 | 3.0 | 3.0 | 3.0 | 3.0 | 4.0 | 4.0 | 3.0 |
| 3 | 3.0 | 3.0 | 3.0 | 3.0 | 4.0 | 4.0 | 3.0 | 3.0 | 3.0 | 4.0 | 4.0 | 5.0 | 4.0 | 2.0 |
| 4 | 3.0 | 3.0 | 3.0 | 4.0 | 4.0 | 3.0 | 3.0 | 3.0 | 3.0 | 3.0 | 4.0 | 4.0 | 3.0 | 3.0 |
| 5 | 4.0 | 4.0 | 4.0 | 5.0 | 4.0 | 4.0 | 4.0 | 3.0 | 3.0 | 3.0 | 4.0 | 4.0 | 3.0 | 3.0 |
| 6 | 2.0 | 3.0 | 3.0 | 4.0 | 3.0 | 3.0 | 2.0 | 4.0 | 3.0 | 4.0 | 3.0 | 3.0 | 4.0 | 3.0 |
| 7 | 3.0 | 3.0 | 4.0 | 3.0 | 5.0 | 4.0 | 4.0 | 3.0 | 3.0 | 4.0 | 3.0 | 4.0 | 5.0 | 3.0 |
| 8 | 3.0 | 4.0 | 4.0 | 4.0 | 4.0 | 3.0 | 3.0 | 3.0 | 4.0 | 3.0 | 4.0 | 4.0 | 3.0 | 3.0 |
| 9 | 2.0 | 2.0 | 3.0 | 3.0 | 3.0 | 4.0 | 3.0 | 2.0 | 3.0 | 3.0 | 3.0 | 4.0 | 4.0 | 2.0 |
| 10 | 3.0 | 3.0 | 3.0 | 4.0 | 4.0 | 4.0 | 3.0 | 3.0 | 4.0 | 3.0 | 4.0 | 5.0 | 4.0 | 3.0 |
| 11 | 2.0 | 4.0 | 4.0 | 3.0 | 4.0 | 5.0 | 4.0 | 2.0 | 3.0 | 4.0 | 3.0 | 3.0 | 3.0 | 3.0 |
| 12 | 3.0 | 3.0 | 4.0 | 4.0 | 5.0 | 4.0 | 3.0 | 4.0 | 4.0 | 3.0 | 4.0 | 5.0 | 4.0 | 2.0 |
| 13 | 2.0 | 4.0 | 4.0 | 3.0 | 5.0 | 3.0 | 3.0 | 3.0 | 3.0 | 4.0 | 3.0 | 3.0 | 4.0 | 2.0 |
| 14 | 3.0 | 3.0 | 3.0 | 5.0 | 5.0 | 4.0 | 3.0 | 3.0 | 3.0 | 4.0 | 5.0 | 5.0 | 4.0 | 4.0 |
| 15 | 4.0 | 3.0 | 4.0 | 3.0 | 4.0 | 4.0 | 3.0 | 3.0 | 4.0 | 3.0 | 4.0 | 4.0 | 3.0 | 3.0 |
| 16 | 3.0 | 4.0 | 4.0 | 4.0 | 4.0 | 5.0 | 3.0 | 3.0 | 3.0 | 3.0 | 3.0 | 4.0 | 4.0 | 4.0 |
| 17 | 2.0 | 3.0 | 3.0 | 4.0 | 5.0 | 4.0 | 2.0 | 2.0 | 3.0 | 4.0 | 5.0 | 4.0 | 3.0 | 4.0 |
| 18 | 4.0 | 3.0 | 4.0 | 4.0 | 4.0 | 5.0 | 3.0 | 3.0 | 4.0 | 3.0 | 4.0 | 4.0 | 3.0 | 3.0 |
| 19 | 3.0 | 3.0 | 3.0 | 3.0 | 4.0 | 4.0 | 3.0 | 3.0 | 4.0 | 4.0 | 4.0 | 4.0 | 3.0 | 3.0 |
| 20 | 2.0 | 3.0 | 4.0 | 4.0 | 5.0 | 4.0 | 3.0 | 3.0 | 3.0 | 3.0 | 3.0 | 4.0 | 3.0 | 3.0 |
| Average | 2.8 | 3.3 | 3.6 | 3.8 | 4.1 | 3.85 | 3.05 | 2.9 | 3.3 | 3.4 | 3.65 | 4.05 | 3.6 | 2.9 |

Finally, in the case of Fortunella japonica, it can be seen that, when the combined fragrance further included 1.5 to 3.9% by weight of α-farnesene in addition to the main aromatic components of Citrus sudachi such as β-ocimene, 6-methyl-5-hepten-2-one, anthranilaldehyde, limonene, and methyl anthranilate, the combined fragrance was able to be used to reproduce the aroma of Fortunella japonica and had high palatability (2.9 or more in average), as listed in Table 26. In particular, it can be seen that, when the combined fragrance further included 2.7 to 3.9% by weight of α-farnesene (#DD, #EE, and #FF), the combined fragrance had very high similarity with the aroma of Fortunella japonica and very excellent aroma palatability (3.6 or more in average).

Meanwhile, it can be seen that, when the jasmone, the β-caryophyllene, the γ-terpinene, and α-farnesene were included at the content less than or greater than a reference range, similarity and palatability of the aroma were reduced.

### [Preparative Example 1] Preparation of Perfume

As described above, the fragrance compositions having similarity with the aroma of Citrus unshiu, Citrus natsudaidai, Citrus sudachi, and Fortunella japonica were blended to prepare a perfume having compositions as listed in the following Table 27.

TABLE 27
Perfume including fragrance composition for
reproducing aroma of Citrus flowers

| | |
|---|---|
| Combined fragrance for reproducing | 15% by weight |
| aroma of Citrus flowers | |
| Alcohol | 83% by weight |
| Water | 2% by weight |
| Pigment | Proper amount |
| Sunscreen | Proper amount |

### INDUSTRIAL APPLICABILITY

The fragrance composition for reproducing the inherent aroma of each of Citrus unshiu, Citrus natsudaidai, Citrus sudachi, and Fortunella japonica according to the present invention can be prepared through blending with a skin base for external use such as perfumes, cosmetics, etc.

1. A fragrance composition comprising as active ingredients:
aromatic components of Citrus flowers; and
one selected from the group consisting of jasmone, β-caryophyllene, γ-terpinene, α-farnesene, and a combination thereof.

2. The fragrance composition of claim 1, wherein the fragrance composition comprises:
the aromatic components of the Citrus flowers comprising linalool, myrcene, nerolidol, and methyl anthranilate; and jasmone.

3. The fragrance composition of claim 1, wherein the fragrance composition comprises:
the aromatic components of the Citrus flowers comprising linalool, myrcene, nerolidol, and methyl anthranilate; and β-caryophyllene.

4. The fragrance composition of claim 1, wherein the fragrance composition comprises:
the aromatic components of the Citrus flowers comprising linalool, myrcene, geraniol, and β-ocimene; and γ-terpinene.

5. The fragrance composition of claim 1, wherein the fragrance composition comprises:
the aromatic components of the Citrus flowers comprising β-ocimene, 6-methyl-5-hepten-2-one, anthranilaldehyde, limonene, and methyl anthranilate; and α-farnesene.

6. The fragrance composition of claim 2, wherein the fragrance composition comprises:
the aromatic components of the Citrus flowers comprising 60 to 69% by weight of linalool, 4.5 to 6.5% by weight of myrcene, 4.2 to 5.6% by weight of nerolidol, and 3.8 to 5.3% by weight of methyl anthranilate; and 0.9 to 5% by weight of jasmone.

7. The fragrance composition of claim 3, wherein the fragrance composition comprises:
the aromatic components of the Citrus flowers comprising 50 to 60% by weight of linalool, 18 to 23% by weight of methyl anthranilate, 8 to 12% by weight of nerolidol, and 3.8 to 6% by weight of myrcene; and 0.9 to 5% by weight of 3-caryophyllene.

8. The fragrance composition of claim 4, wherein the fragrance composition comprises:
the aromatic components of the Citrus flowers comprising 53 to 62% by weight of linalool, 10 to 15% by weight of myrcene, 3 to 7% by weight of geraniol, and 3 to 5% by weight of βocimene; and 0.9 to 5% by weight of γ-terpinene.

9. The fragrance composition of claim 5, wherein the fragrance composition comprises:
the aromatic components of the Citrus flowers comprising 17 to 25% by weight of β-ocimene, 10 to 16% by weight of 6-methyl-5-hepten-2-one, 9 to 14% by weight of anthranilaldehyde, 9 to 14% by weight of limonene, and 9 to 14% by weight of methyl anthranilate; and 0.9 to 5% by weight of α-farnesene.

10. The fragrance composition of claim 2, wherein the aromatic component of the Citrus flowers further comprise one or more selected from the group consisting of anthranilaldehyde, 3,7-dimethyl-1,5-octadiene-3,7-diol, phenylacetonitrile, 6-methyl-5-hepten-2-one, phenylethyl alcohol, limonene, and indole.

11. The fragrance composition of claim 3, wherein the aromatic component of the Citrus flowers further comprise one or more selected from the group consisting of anthranilaldehyde, 3,7-dimethyl-1,5-octadiene-3,7-diol, phenylacetonitrile, 6-methyl-5-hepten-2-one, phenylethyl alcohol, limonene, and indole.

12. The fragrance composition of claim 4, wherein the aromatic component of the Citrus flowers further comprise one or more selected from the group consisting of 3,7-dimethyl-1,5-octadiene-3,7-diol, phenylacetonitrile, 6-methyl-5-hepten-2-one, phenylethyl alcohol, limonene, indole, β-caryophyllene, and nonanal.

13. The fragrance composition of claim 5, wherein the aromatic component of the Citrus flowers further comprise one or more selected from the group consisting of ethyl acetate, linalool, nonanal, decanal, α-pinene, acetophenone, and indole.

14. The fragrance composition of claim 1, wherein the aromatic components of the Citrus flowers are aromatic components of flowers of Citrus unshiu.

15. The fragrance composition of claim 1, wherein the aromatic components of the Citrus flowers are aromatic components of Citrus natsudaidai.

16. The fragrance composition of claim 1, wherein the aromatic component of the Citrus flowers are aromatic component of flowers of Citrus sudachi.

17. The fragrance composition of claim 1, wherein the aromatic components of the Citrus flowers are aromatic components of flowers of Fortunella japonica.

18. A skin preparation for external use including the fragrance composition defined in claim 1.
